(19) United States
(12) Patent Application Publication
(10) Pub. No.: US 2012/0133807 A1
(43) Pub. Date: May 31, 2012

(54) IMAGE CAPTURE DEVICE

(75) Inventors: Cheng-Wen Wu, Tainan City (TW); Ding-Ming Kwai, Zhubei City (TW); Jim Li, Taipei City (TW); Ka-Yi Yeh, Hsinchu City (TW)

(73) Assignee: Industrial Technology Research Institute

(21) Appl. No.: 12/977,495

(22) Filed: Dec. 23, 2010

(30) Foreign Application Priority Data
Nov. 30, 2010 (TW) 099141521

(51) Int. Cl. H04N 5/335

(52) U.S. Cl. 348/272; 348/302; 348/308; 348/E05.091

(57) ABSTRACT

An image capture apparatus comprises an image sensor array including a plurality of image sensors arranged in a two-dimensional (2-D) array and an analog-to-digital converter (ADC) array including a plurality of ADCs arranged in a 2-D array. The image sensor array is divided into a plurality of sub-arrays, each of which includes at least two image sensors. The image sensor array is vertically stacked on the ADC array. Each ADC corresponds to one sub-array of image sensors and is coupled to process signals output by the image sensors in the corresponding sub-array.

### TECHNOLOGY FIELD

The present disclosure relates to an image capture apparatus and, more particularly, to an image capture apparatus with die stacking.

### BACKGROUND

A digital image capture apparatus may include an analog circuit and a digital circuit. The analog circuit may further include two components. One component is an image sensing device for capturing images by detecting the intensity of incident light and converting the intensity to an analog electrical signal via a photoelectric effect. The other component of the analog circuit is an analog-to-digital converter (ADC), which converts the analog signal to a digital signal. The resulting digital signal is then processed by an image signal processor (ISP) and saved into a memory.

Depending on preference, the three functions mentioned above may be realized using a single chip or multiple chips. For portable electronic devices, besides high performance (such as high resolution, high image quality, and high frame rate), there is a desire for low power consumption and small size. Nowadays, to reduce the size of an electronic device, one approach is to increase the level of integration. However, for image capture apparatus, it may be difficult to integrate different components into one chip, due to different process and design requirements for the different components of the image capture apparatus. For example, the image sensing device should have good sensitivity to incident light. Therefore, when designing an image sensing device, one may need to increase the area of each photo diode included in the device and minimize the number of metal layers or other elements that may block incident light. On the other hand, an ADC may need more metal layers to reduce wiring area and to improve efficiency. Further, to reduce occupied area and manufacturing cost of an ISP, a more advanced manufacturing process may need to be employed. Accordingly, different components of an image capture apparatus may have requirements that conflict with each other.

In addition, increasing the number of pixels and frame rate are design trends of image capture apparatus. Increasing the number of pixels and frame rate in turn increases the requirement for bandwidth for transferring image data from the image sensing device to the ADC and from the ADC to the ISP. This can be accomplished by providing more signal pins or increasing the transfer rate. However, for an analog circuit, both approaches may affect the quality of the overall signal, and thus reduce the quality of the final image. Moreover, a fabrication process may limit the maximum transfer rate that can be realized, and the number of pins is also limited by factors such as fabrication process, circuit design, or layout.

Therefore, it may be desired that the image sensing device, the ADC, and the ISP of an image capture apparatus be designed individually and manufactured by their respective processes, and then coupled to each other. Recently, a 3D die-stacking technology has been used to realize higher performance and higher density heterogeneous system integration. According to the 3D die-stacking technology, each die may be manufactured using a process that is the most suitable for it, and then different dies may be vertically stacked one on each other using interconnects such as through silicon vias (TSVs), micro bumps, and/or redistribution layers (RDL). With this type of architecture, data output from different pixels of the image sensing device may be transferred to the ADCs simultaneously, and the converted data output from the ADCs may also be transferred to the ISPs simultaneously. This may ensure broader transmission bandwidth.

Image capture apparatus may experience fixed pattern noise (FPN), which is a particular noise pattern in which different pixels exhibit different brightness under the same illumination. FPN may be caused by various factors, such as non-uniform sensitivity of different pixels of the image sensing device, non-uniform properties across the reading circuit, and ADC offset/gain mismatch.

### SUMMARY

In accordance with the present disclosure, there is provided an image capture apparatus comprising an image sensor array including a plurality of image sensors arranged in a two-dimensional (2-D) array and an analog-to-digital converter (ADC) array including a plurality of ADCs arranged in a 2-D array. The image sensor array may be divided into a plurality of sub-arrays, each of which may include at least two image sensors. The image sensor array may be stacked on the ADC array. Each ADC corresponds to one sub-array of image sensors and is coupled to process signals output by the image sensors in the corresponding sub-array.

Features and advantages consistent with the present disclosure will be set forth in part in the description which follows, and in part will be obvious from the description, or may be learned by practice of the present disclosure. Such features and advantages will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a schematic perspective view of a stack of dies for an image capture apparatus according to embodiments consistent with the present disclosure.

FIG. 2 is a schematic perspective view of an image sensor array consistent with the present disclosure.

FIG. 3 is a schematic perspective view of an ADC array consistent with the present disclosure.

FIG. 4 is a schematic perspective view of the status after the image sensor array is stacked on the ADC array.

FIGS. 5(A) and 5(B) are schematic cross-sectional views of the image sensor array and the ADC array, respectively, each formed on a substrate.

FIG. 6 is a schematic cross-sectional view of the status after the image sensor array is bonded to the ADC array face-to-face.

FIG. 7 is a schematic perspective view of an ISP array consistent with the present disclosure.

FIG. 8 is a schematic cross-sectional view of the status after the ADC array, with image sensor array bonded thereto, is bonded to the ISP array face-to-back.

FIG. 9 is a schematic cross-sectional view of the status after a stack of the image sensor array, the ADC array, and the ISP array is bonded to an assembly substrate via wire bonding.

FIG. 10 is a schematic cross-sectional view of the status after the stack of the image sensor array, the ADC array, and the ISP array is bonded to an assembly substrate via TSVs.

### DESCRIPTION OF THE EMBODIMENTS

Embodiments consistent with the present disclosure include an image capture apparatus with 3D die stacking, which has an improved performance and a small size.

Hereinafter, embodiments consistent with the present disclosure will be described with reference to drawings. Wherever possible, the same reference numbers will be used throughout the drawings to refer to the same or like parts.

FIG. 1 is a schematic perspective view of a stack 100 of dies for an image capture apparatus according to embodiments consistent with the present disclosure. The stack 100 includes an image sensor array 102, an ADC array 104, and an ISP array 106 vertically stacked one on the other. Each of these arrays will be separately described in detail below. For simplicity, in each of the perspective views shown in FIGS. 1-4 and 7, the substrates on which the arrays are formed are omitted.

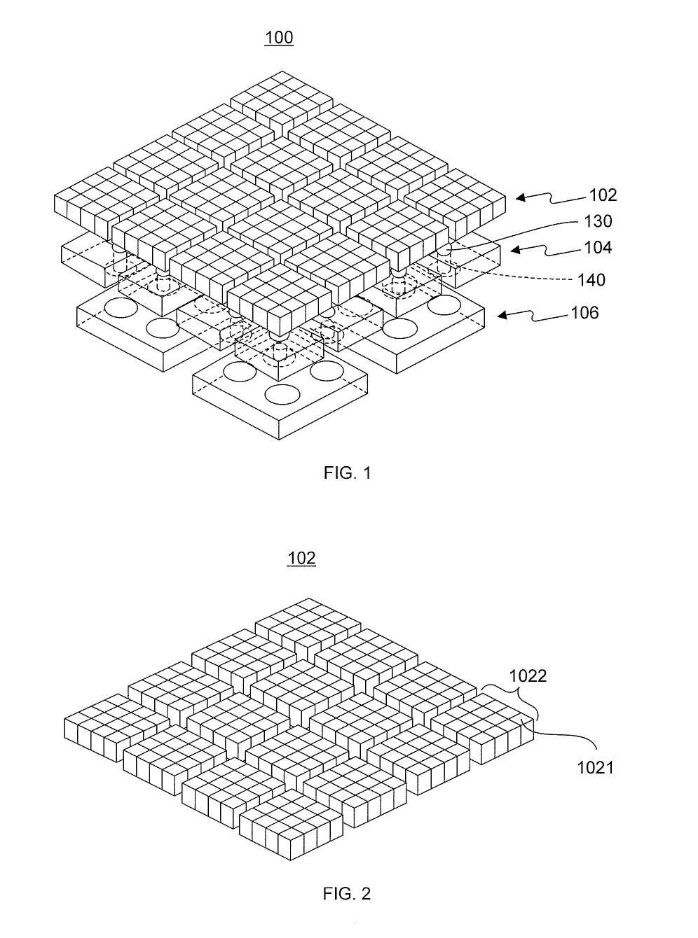

FIG. 2 is a schematic perspective view of the image sensor array 102. The image sensor array 102 includes a plurality of image sensors 1021 arranged in a two-dimensional (2D) array. The image sensor 1021 may be any type of opto-electronic device that is capable of detecting electromagnetic waves and converting an optical signal to an electrical signal. In some embodiments, the image sensors 1021 may be CMOS sensors.

The image sensor 1021 may be identical, similar, or different sensors. For example, in some embodiments, some of the image sensors 1021 may be red sensors having peak sensitivity at a wavelength corresponding to a red light, some of the image sensors 1021 may be green sensors having peak sensitivity at a wavelength corresponding to a green light, and some of the image sensors 1021 may be blue sensors having peak sensitivity at a wavelength corresponding to a blue light. The image output by image capture apparatus consistent with these embodiments may be a color image. In some other embodiments, all of the image sensors 1021 may be the same type of sensors and the output image may be a gray-scale image.

Consistent with embodiments of the present disclosure, the image sensor array 102 may be divided into a plurality of sub-arrays. In some embodiments, such as shown in FIG. 2, each sub-array of image sensors may include a block 1022 of M×N image sensors, where M and N are integers and at least one of them is larger than one (1). In some embodiments, M and N may be different integers. In some embodiments, M may equal N. Each block 1022 of image sensors may include the same or a different number of image sensors. For example, each block of image sensors may include 4×4, 6×6, 8×8, 50×50, or 128×192 image sensors.

In some embodiments, the blocks 1022 of image sensors may be separated from each other by a physically defined boundary. For example, each block 1022 may be separated from neighboring blocks by a trench or an insulating film. In some embodiments, the blocks 1022 of image sensors may be “virtually” separated from each other. For example, there may be no difference between the boundary between image sensors within one block 1022 and the boundary between image sensors in two neighboring blocks 1022. In the latter case, neighboring image sensors coupled to one ADC in the ADC array 104 via coupling means, such as micro bumps and redistribution layer, may be defined as one block 1022.

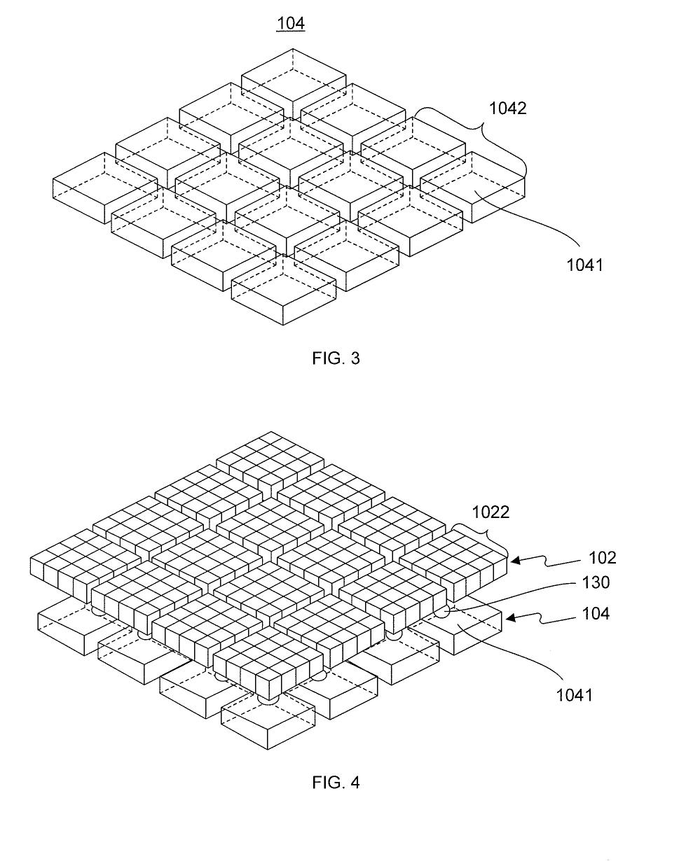

FIG. 3 is a schematic perspective view of the ADC array 104. The ADC array 104 includes a plurality of ADCs 1041 arranged in a 2D array. Consistent with embodiments of the present disclosure, one ADC 1041 in the ADC array 104 corresponds to one sub-array of image sensors, and may be coupled to process signals output by the image sensors in the corresponding sub-array of image sensors. FIG. 4 schematically shows the status after the image sensor array 102 is stacked on the ADC array 104. As shown in FIG. 4, one ADC 1041 corresponds to one block 1022 of image sensors.

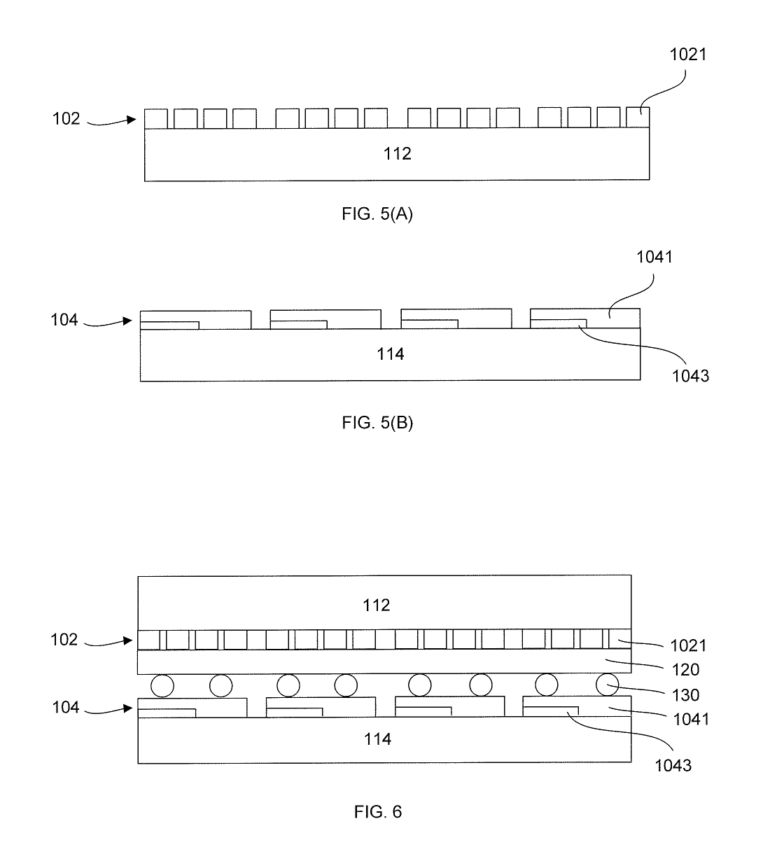

With reference to FIGS. 5(A) and 5(B), and consistent with embodiments of the present disclosure, the image sensor array 102 and the ADC array 104 may be formed on different substrates by their respective processes. For example, the image sensor array 102 may be formed on one surface of a substrate 112, as shown in FIG. 5(A). The ADC array 104 may be formed on one surface of another substrate 114, as shown in FIG. 5(B). In some embodiments, the image sensors 1021 may be backside illuminated image sensors, and thus the image sensor array 102 and the ADC array 104 may be bonded in a manner that the backsides of the image sensors 1021 face the incident light. FIG. 6 illustrates such an embodiment utilizing backside illuminated image sensors. With reference to FIG. 6, the image sensor array 102 and the ADC array 104 are bonded to each other face-to-face. That is, when bonding the image sensor array 102 and the ADC array 104, the substrate 112 is turned upside down so that the surface of substrate 112 on which the image sensor array 102 is formed faces the surface of substrate 114 on which the ADC array 104 is formed.

With such a configuration as shown in FIG. 6, a backside of the image sensor array 102 on which the incoming light is incident may be free of metal layers, so that loss of light due to blockage by metal layers may be minimized. Since the incoming light passes through substrate 112, substrate 112 may comprise a material having a low absorption rate with respect to the incoming light, such as silicon. To reduce light blockage by substrate 112, substrate 112 may be thinned after the image sensor array 102 is formed.

In some embodiments, a redistribution layer 120 and conductive micro bumps 130 may be formed between the facing image sensors 1021 and ADCs 1041, so as to couple the image sensor array 102 to the ADC array 104. Redistribution layer 120 may be used to connect electrodes not vertically aligned with each other. Analog signals output by one image sensor 1021 may be transferred to its corresponding ADC through the redistribution layer 120 and the micro bumps 130. The ADC may then convert the analog signal to a digital signal for sending to an ISP for further processing.

As previously described, there may exist FPN in an image capture apparatus. A compensation algorithm may be employed to compensate for FPN. Consistent with embodiments of the present disclosure, the compensation algorithm to compensate for FPN may be stored in memories 1043 of the ADCs 1041. In some embodiments, the compensation algorithm may be a linear function of Y=aX+b, where X and Y are the input and output data, respectively, and a and b are compensating parameters. In some embodiments, the compensation algorithm may be a piecewise linear (PWL) function, in which different linear functions (e.g., different values of a and b) are applied when input X falls in different ranges. In some embodiments, the compensation algorithm may be a nonlinear function, such as Y=cX²+aX+b, where c is an additional compensating parameter.

Consistent with embodiments of the present disclosure, results provided by the compensation algorithm may also be stored in the memories 1043 of the ADCs 1041. Thus, compensation may be quickly achieved and the cost and power consumption may also be reduced.

Referring back to FIG. 3, similar to the image sensor array 102, the ADC array 104 may also be divided into a plurality of sub-arrays such as a plurality of blocks 1042. Each block 1042 includes at least one ADC 1041. In the example shown in FIG. 3, each block 1042 may include a plurality of ADCs 1041, e.g., two. As will be described in further detail below, ADCs in one sub-array or block 1042 may correspond to one ISP and output signals to the corresponding ISP.

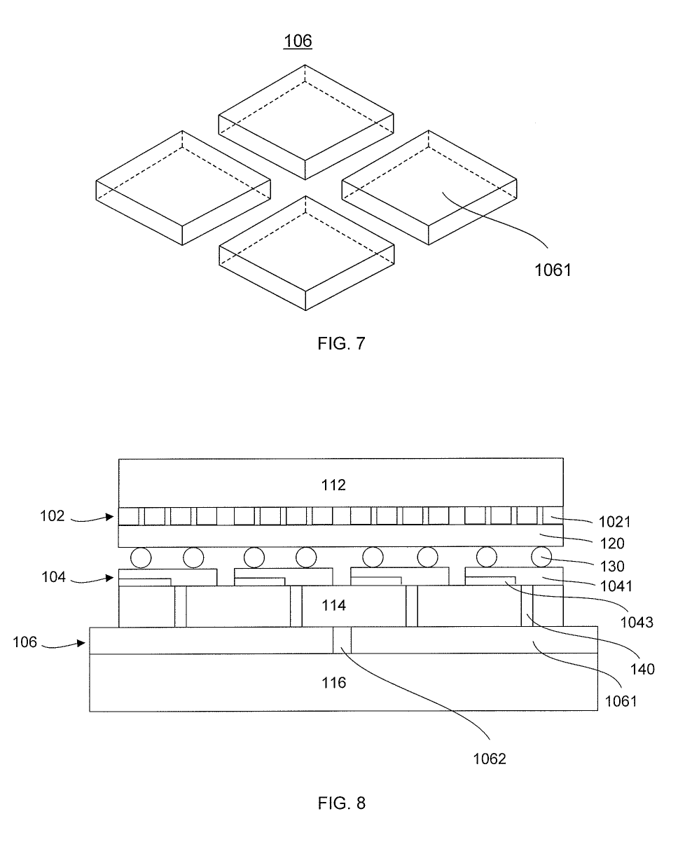

FIG. 7 is a schematic perspective view of the ISP array 106. In some embodiments, the ISP array 106 may include one ISP. In some embodiments, the ISP array 106 may include a plurality of ISPs 1061 arranged in a 2D array, as shown in FIG. 7. Consistent with embodiments of the present disclosure, one ISP 1061 in the ISP array 106 corresponds to one sub-array of ADCs. One ISP 1061 may be coupled to process signals output by the ADCs in the corresponding sub-array of ADCs. This correspondence may also be seen in FIG. 1.

With reference to FIG. 8 which is a cross-sectional view of the status after the ADC array 104 is bonded to the ISP array 106 face-to-back, and consistent with embodiments of the present disclosure, the ISP array 106 may be formed on one surface of a substrate 116. In some embodiments, the ADC array 104 may be bonded to the ISP array 106 face-to-back. As illustrated in FIG. 8, the ADC array 104 may be stacked on top of the ISP array 106 with the bottom surface of substrate 114 on which no ADCs are formed facing the ISP array 106. TSVs 140 may be formed through substrate 114 to form electrical connections between the ADC array 104 and the ISP array 106. Conductive micro bumps 130 and TSVs 140 are also shown in FIG. 1. A redistribution layer and conductive micro bumps (not shown) may also be formed between substrate 114 and the ISP array 106, serving as optional electrical connections to facilitate the connection between the TSVs 140 and the ISP array 106. FIG. 8 illustrates a space 1062 between adjacent ISPs 1061. However, ISPs 1061 may also be formed in a manner such that there is no space between adjacent ISPs 1061.

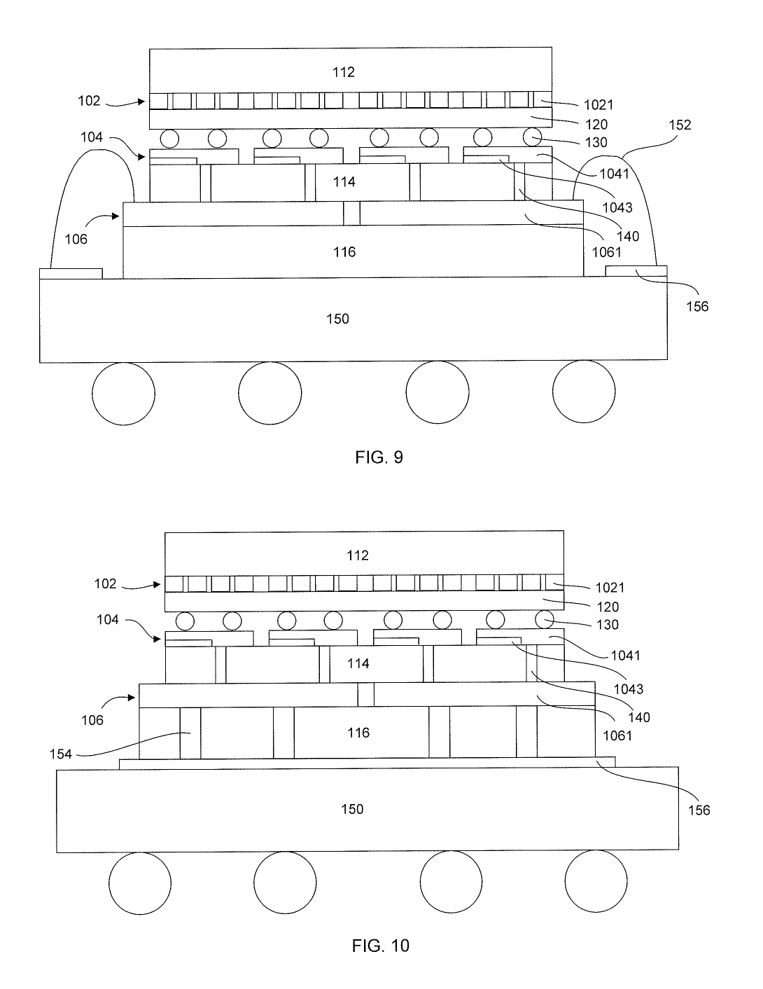

FIG. 9 is a schematic cross-sectional view of the status after the stack 100 of the image sensor array 102, the ADC array 104, and the ISP array 106 is bonded to an assembly substrate 150 via wire bonding. FIG. 10 is a schematic cross-sectional view of the status after the stack 100 of the image sensor array 102, the ADC array 104, and the ISP array 106 is bonded to an assembly substrate 150 via TSVs 154. As shown in FIGS. 9 and 10, in some embodiments, the stack of image sensor array 102, ADC array 104, and ISP array 106 may be bonded to an assembly substrate 150. The assembly substrate 150 may have a control circuit 156 formed thereon for controlling the operation of the image capture apparatus. In some embodiments, bonding wires 152 may be used to electrically connect the ISP array 106 to the control circuit 156, such as shown in FIG. 9. In some embodiments, TSVs 154 may be formed in substrate 116 to electrically connect the ISP array 106 to the control circuit 156, such as shown in FIG. 10.

An image capture apparatus consistent with the present disclosure may have a smaller footprint as compared to conventional image capture apparatus. The area on a printed circuit board occupied by an image capture apparatus consistent with the present disclosure may be approximately the area of the largest one of the image sensor array, the ADC array, and the ISP array. Therefore, an image capture apparatus consistent with the present disclosure is, for example, suitable for portable electronic devices. In addition, an image capture apparatus consistent with present disclosure has good scalability.

Other embodiments of the present disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An image capture apparatus comprising:
an image sensor array including a plurality of image sensors arranged in a two-dimensional array, the image sensor array being divided into a plurality of sub-arrays, each sub-array including at least two image sensors;
an analog-to-digital converter (ADC) array including a plurality of ADCs arranged in a 2-D array,
wherein the image sensor array is stacked on the ADC array, and
wherein each ADC corresponds to one of the sub-arrays of image sensors and is coupled to process signals output by the image sensors in the corresponding sub-array.

2. The image capture apparatus according to claim 1, wherein:
each sub-array of image sensors includes a block of M×N image sensors, M and N being integers, and
at least one of M and N is larger than one.

3. The image capture apparatus according to claim 2, wherein M equals N.

4. The image capture apparatus according to claim 1, wherein each sub-array of image sensors includes a same number of image sensors.

5. The image capture apparatus according to claim 1, wherein:
the image sensor array and the ADC array are formed on a first substrate and a second substrate, respectively, and
the image sensor array and the ADC array are bonded face-to-face.

6. The image capture apparatus according to claim 5, wherein the image sensor array and the ADC array are coupled to each other using a redistribution layer and micro bumps.

7. The image capture apparatus according to claim 1, wherein the image sensors are backside illuminated image sensors.

8. The image capture apparatus according to claim 1, wherein the image sensors are CMOS image sensors.

9. The image capture apparatus according to claim 1, wherein each image sensor is one of a red sensor, a green sensor, or a blue sensor.

10. The image capture apparatus according to claim 1, wherein each ADC includes a memory for storing a compensation algorithm and compensating results.

11. The image capture apparatus according to claim 10, wherein the compensation algorithm is configured to compensate for a fixed pattern noise.

12. The image capture apparatus according to claim 1, further comprising an image signal processor (ISP) array, the ISP array including at least one ISP.

13. The image capture apparatus according to claim 12, wherein:
the ISP array includes a plurality of ISPs,
the ADC array is divided to a plurality of sub-arrays, and
each ISP processes signals output by one of the sub-arrays of the ADCs.

14. The image capture apparatus according to claim 12, wherein the image sensor array and the ADC array are stacked on the ISP array.

15. The image capture apparatus according to claim 14, wherein:
the image sensor array, the ADC array, and the ISP array are formed on a first substrate, a second substrate, and a third substrate, respectively,
the image sensor array and the ADC array are bonded face-to-face, and
the ADC array and the ISP array are bonded face-to-back.

16. The image capture apparatus according to claim 15, wherein the ADC array and the ISP array are coupled to each other using through silicon vias (TSVs) formed in the second substrate.

17. The image capture apparatus according to claim 12, further comprising a control circuit formed on an assembly substrate.

18. The image capture apparatus according to claim 17, wherein the ISP array is coupled to the control circuit using wires.

19. The image capture apparatus according to claim 17, wherein the ISP array is connected to the control circuit using TSVs formed in the third substrate.
